(19) United States
(12) Patent Application Publication
(10) Pub. No.: US 2024/0224176 A1
(43) Pub. Date: Jul. 4, 2024

(54) METHOD AND APPARATUS FOR SAVING UE POWER IN A DISCONTINUOUS SERVICE LINK COVERAGE SCENARIO

(71) Applicant: LENOVO (BEIJING) LIMITED, BEIJING (CN)

(72) Inventors: MIN XU, BEIJING (CN); LIANHAI WU, BEIJING (CN); HAIMING WANG, BEIJING (CN); JING HAN, BEIJING (CN); RAN YUE, BEIJING (CN); JIE SHI, BEIJING (CN); JIE HU, BEIJING (CN)

(21) Appl. No.: 18/558,174

(22) PCT Filed: Apr. 30, 2021
(86) PCT No.: PCT/CN2021/091495

§ 371 Date: Oct. 30, 2023

(51) Int. Cl. H04W 52/02; H04W 76/28; H04W 84/06

(52) U.S. Cl. CPC H04W 52/0216; H04W 76/28; H04W 84/06

(57) ABSTRACT

Embodiments of the present disclosure relate to methods and apparatuses for saving power of a user equipment (UE) in a discontinuous service link coverage scenario in a non-terrestrial network (NTN). According to an embodiment of the present disclosure, a method which may be performed by a UE includes: determining a time; and entering a power saving mode (PSM) of the UE at the time, wherein the time is associated with at least one of: a timer relating to the PSM of the UE; and a coverage interruption of a network.

### TECHNICAL FIELD

Embodiments of the present disclosure generally relate to wireless communication technology, especially to a method and apparatus for saving power of a user equipment (UE) in a discontinuous service link coverage scenario in a non-terrestrial network (NTN).

### BACKGROUND

An NTN may refer to a network, or a segment of a network, using an airborne or space-borne vehicle to embark an NTN payload. An NTN payload may perform the desired communication function of a satellite or a high altitude platform station (HAPS), between the service and the feeder link. An NTN payload may be embarked on board space/airborne vehicle. The satellite in NTN can be a geostationary earth orbiting (GEO) satellite with fixed location with respect to the Earth, or a low earth orbiting (LEO) satellite orbiting around the Earth. In 3rd Generation Partnership Project (3GPP) Rel-17, NTN using new radio (NR) air interface is discussed in the work item “Solutions for NR to support NTN”, and NTN using long-term evolution (LTE) air interface for internet of things (IOT) user equipment (UE) is discussed in the study item “Study on NB-IOT/eMTC support for NTN.” “NB-IOT/eMTC” stands for “narrow band-IoT/enhanced machine type communication.”

In the discussions for “Study on NB-IOT/eMTC support for NTN” scenarios (3GPP R1-2008868 and R2-2011228), satellite service providers are proposed to include microsatellite platforms (as known as Cube satellites) with limited size and power and low-density constellations, which have restricted link budget and discontinuous service link coverage where UE devices can remain long periods of time without being able to detect a satellite cell. In 3GPP RAN2 #103 meeting, a discontinuous service link coverage scenario from RAN2 perspective is discussed in 3GPP R2-2102248. It is expected that RAN2 will study an effect of the discontinuous service link coverage scenario after RAN1 has made some progress on this aspect. The discontinuous service link coverage scenario may also be named as “a discontinuous coverage scenario”, “a discontinuous network coverage scenario”, “a coverage hole scenario”, or the like.

### SUMMARY

For an NTN, a discontinuous coverage scenario can happen in space and/or a time domain due to a satellite (and a UE) movement. It may lead to additional and unnecessary power consumption, which is at least essential to IoT devices. Meanwhile, the regular trajectory of NTN platforms (e.g., a LEO satellite) as well as the low mobility of IoT devices provide room for an enhancement. The present disclosure provides novel methods and apparatus for a UE's power saving and enhancements in a discontinuous coverage scenario in an NTN.

Some embodiments of the present disclosure provide a method, which may be performed by a UE. The method includes: determining a time; and entering a power saving mode (PSM) of the UE at the determined time, wherein the determined time is associated with: a timer relating to the PSM of the UE; and/or a coverage interruption of a network.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE.

Some embodiments of the present application also provide a UE. The UE includes a processor and a wireless transceiver coupled to the processor; and the processor is configured to determine time and enter a PSM of the UE at the determined time, wherein the determined time is associated with: a timer relating to the PSM of the UE; and/or a coverage interruption of a network.

Some embodiments of the present application provide a method, which may be performed by a network device (e.g., a radio access network device (RAN) device and/or a core network (CN) device). The method includes: determining configuration information regarding a timer relating to a PSM of a UE; and transmitting a message to the UE, wherein the message includes the configuration information regarding the timer relating to the PSM, and wherein the network device is a RAN device and/or a CN device.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned further method performed by a network device (e.g., a RAN device and/or a CN device).

Some embodiments of the present application also provide a network device (e.g., a RAN device and/or a CN device). The network device includes a processor; and a wireless transceiver coupled to the processor, and the processor is configured: to determine configuration information regarding a timer relating to a PSM of a UE; and to transmit a message to the UE, wherein the message includes the configuration information regarding the timer relating to the PSM, and wherein the network device is a RAN device and/or a CN device.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1A and FIG. 1B illustrate two exemplary wireless communication systems according to some embodiments of the present disclosure.

FIG. 2A illustrates a schematic diagram illustrating an Attach procedure according to 3GPP standard document TS23.401.

FIG. 2B illustrates a schematic diagram illustrating a tracking area update (TAU) procedure according to 3GPP standard document TS23.401.

FIG. 3 illustrates an exemplary time relation of a PSM and a network coverage according to some embodiments of the present disclosure.

FIG. 4 illustrates an exemplary flow chart of a method for entering a PSM of a UE according to some embodiments of the present application.

FIG. 5 illustrates an exemplary flow chart of a method for determining configuration information regarding a timer relating to a PSM of a UE according to some embodiments of the present application.

FIG. 6 illustrates an exemplary flow chart for entering and/or leaving a PSM of a UE according to some embodiments of the present disclosure.

FIG. 7 illustrates a further exemplary flow chart for entering and/or leaving a PSM of a UE according to some embodiments of the present disclosure.

FIG. 8 illustrates another exemplary flow chart for entering and/or leaving a PSM of a UE according to some embodiments of the present disclosure.

FIG. 9 illustrates an additional exemplary flow chart for entering and/or leaving a PSM of a UE according to some embodiments of the present disclosure.

FIGS. 10A and 10B illustrate two exemplary formats of an offset time value for a timer relating to a PSM of a UE according to some embodiments of the present disclosure.

FIG. 11 illustrates an exemplary block diagram of an apparatus according to some embodiments of the present application.

### DETAILED DESCRIPTION

The detailed description of the appended drawings is intended as a description of the currently preferred embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

Also, the use of the expression “A and/or B” means any one of the following: “A” alone or “B” alone; or both “A” and “B” together.

Reference will now be made in detail to some embodiments of the present disclosure, examples of which are illustrated in the accompanying drawings. To facilitate understanding, embodiments are provided under specific network architecture and new service scenarios, such as 3GPP 5G New Radio (NR), 3GPP long-term evolution (LTE) Release 8 and so on. Persons skilled in the art know very well that, with the development of network architecture and new service scenarios, the embodiments in the present disclosure are also applicable to other similar technical problems.

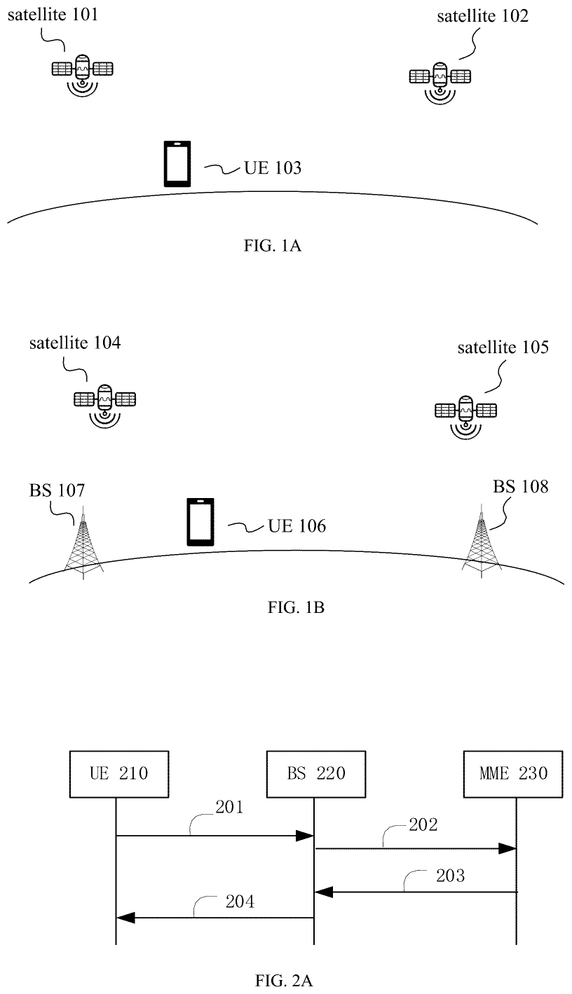

FIG. 1A and FIG. 1B illustrate two exemplary wireless communication systems according to some embodiments of the present disclosure.

In general, a satellite may implement either a transparent payload or a regenerative (with on board processing) payload. FIG. 1A shows communications between a UE and satellites in an NTN regenerative mode. A regenerative payload as shown in FIG. 1A includes functions of: radio frequency filtering, a frequency conversion, and an amplification, as well as “demodulation or decoding”, “switch and/or routing”, and “coding or modulation”. This is effectively equivalent to having all or a part of functions of a base station (BS) on board a satellite. FIG. 1B shows communications between a UE and satellites in an NTN transparent mode. A transparent payload as shown in FIG. 1B includes functions of: radio frequency filtering, a frequency conversion, and amplification. In this case, processing functions of a BS include “demodulation or decoding”, “switch and/or routing”, and “coding or modulation”.

Specifically, FIG. 1A shows satellite 101, satellite 102, and UE 103 for illustrative purpose. UE 103 may be under the coverage of satellite 101. As shown in FIG. 1A, satellite 101 may be in communication with UE 103. In some embodiments, UE 103 may be radio resource control (RRC) connected with satellite 101. UE 103 may be connected with satellite 101 on the RRC layer. Data blocks or data packets may be transmitted and/or received between satellite 101 and UE 103. Data blocks or data packets may be transmitted and/or received in resource blocks between satellite 101 and UE 103. FIG. 1B shows satellite 104, satellite 105, UE 106, BS 107, and BS 108 for illustrative purpose. Satellite 104 and satellite 105 in FIG. 1B have similar functions to those of satellite 101 and satellite 102 in FIG. 1A, and UE 106 in FIG. 1B has similar functions to those of UE 103 in FIG. 1A. BS 107 and BS 108 in FIG. 1B include functions of “demodulation or decoding”, “switch and/or routing”, and “coding or modulation”.

For example, the wireless communication systems in FIGS. 1A and 1B may be compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G NR network, a satellite communications network, a non-terrestrial network, a high altitude platform network, and/or other communications networks. In some embodiments, the wireless communication systems in FIGS. 1A and 1B may be compatible with NB-IOT/eMTC for NTN.

In some embodiments, at least one of satellite 101, satellite 102, satellite 104, and satellite 105 may be referred to as a NodeB, a base unit, a base, an access point, an access terminal, a macro cell, an enhanced Node B (eNB), a gNB, a Home Node-B, a relay node, a device, a remote unit, or by other terminology used in the art. A BS may be distributed over a geographic region. Generally, a BS is a part of a radio access network that may include one or more controllers communicably coupled to one or more corresponding core networks. In some embodiments, at least one of satellite 101, satellite 102, satellite 104, and satellite 105 may be a geostationary earth orbiting (GEO) satellite with fixed location with respect to the Earth, or a low earth orbiting (LEO) satellite orbiting around the Earth.

UE 103 and/or UE 106 may include computing devices such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, UE 103 and/or UE 106 may include a portable wireless communication device, a smart phone, a cellular telephone, a flip phone, a device having a subscriber identity module, a personal computer, a selective call receiver, or any other device capable of transmitting and receiving communication signals on a wireless network. In some embodiments, UE 103 and/or UE 106 may include wearable devices, such as smart watches, fitness bands, optical head-mounted displays, or the like. Moreover, UE 103 and/or UE 106 may be referred to as a subscriber unit, a mobile, a mobile station, a user, a terminal, a mobile terminal, a wireless terminal, a fixed terminal, a subscriber station, a user terminal, or a device, or described with other terminology used in the art.

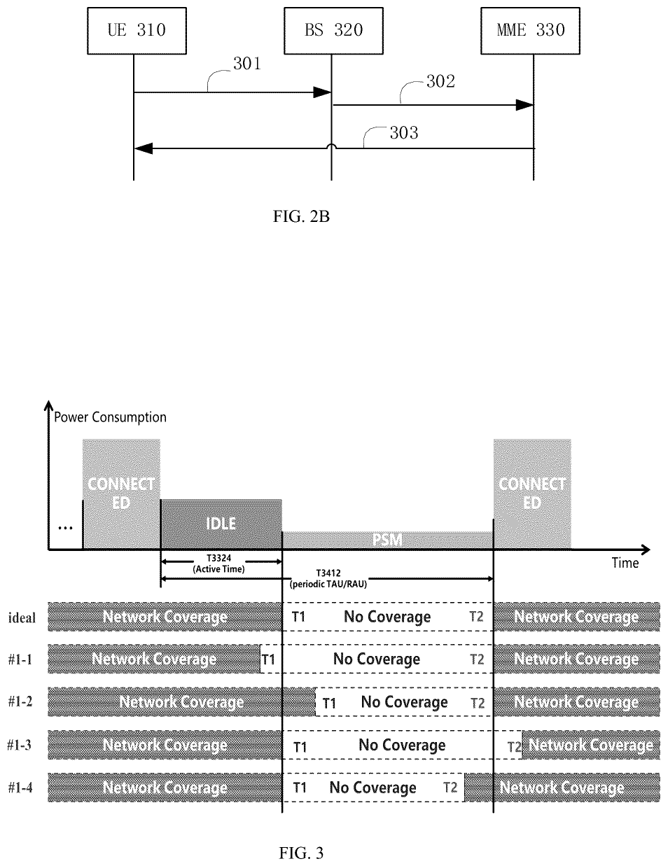

FIG. 2A illustrates a schematic diagram illustrating an Attach procedure according to 3GPP standard document TS23.401. Referring to FIG. 2A, in step 201, UE 210 transmits an Attach Request message to BS 220. In step 202, BS 220 transmits the Attach Request message to MME 230. In step 203, MME 230 transmits an Initial Context Setup Request message or a Downlink NAS transport with Attach Accept message to BS 220. In step 204, BS 220 transmits a RRC Connection Reconfiguration message or a RRC Direct Transfer message to UE 210.

FIG. 2B illustrates a schematic diagram illustrating a tracking area update (TAU) procedure according to 3GPP standard document TS23.401. Referring to FIG. 2B, in step 301, UE 310 transmits a TAU Request message to BS 320. In step 302, BS 320 transmits the TAU Request message to MME 330. In step 303, MME 330 transmits a TAU Accept message to UE 210.

FIG. 3 illustrates an exemplary time relation of a PSM and a network coverage according to some embodiments of the present disclosure.

In accordance with 3GPP standard document TS23.682 v16.8.0, a UE may adopt a PSM for reducing its power consumption. A PSM is similar to power-off, but a UE remains registered with the network and there is no need to re-attach or re-establish packet data network (PDN) connections. A UE can request a use of a PSM during an Attach procedure or a TAU procedure, and a network may accept the use of the PSM by providing an Active Time value for timer T3324 and/or a periodic TAU/RAU value for timer T3412. As shown in FIG. 3, both timer T3324 and timer T3412 start when the UE leaves a CONNECTED state and enters an IDLE state. Upon timer T3324 expiration, the UE may enter a PSM as shown in FIG. 3, if no PDN connection for emergency bearer services is established.

In some embodiments, timer T3324 may adopt a format of “GPRS timer 2” as specified in 3GPP standard document TS24.008 v17.0.0. According to the format of GPRS timer 2, a value range of a timer may be computed as a product of “Timer Unit(s)” and “Timer Value(s) of each Timer Unit”. A Timer Unit may also be named as “a timer length unit”, “a timer length step”, “a timer step”, “a timer granularity”, “a timer length granularity”, “a time unit”, “a time length unit”, “a time length step”, “a time step”, “a time granularity”, “a time length granularity”, or the like. Timer Value(s) of a Timer Unit may also be named as “a range value of a timer granularity”, “a range value of a timer step”, “a timer value of a timer granularity”, “a timer value of a timer step”, “a range value of a time granularity”, “a range value of a time step”, “a timer value of a time granularity”, “a timer value of a time step”, or the like.

In particular, in an embodiment of FIG. 3, timer T3324 adopting the format of GPRS timer 2 may be represented by: Timer Units of {0˜31}; and Timer Values of each Timer Unit of {2 s, 1 min, 10 min}, wherein “2 s” means 2 seconds, and “1 min” means 1 minute. That is, a value range of timer T3324 is {0˜31} *{2 s, 1 min, 10 min}. Thus, a value range of timer T3324 adopting the format of GPRS timer 2 may be {0 s˜310 min}.

In some embodiments, timer T3412 may adopt a format of GPRS timer 3 as specified in 3GPP standard document TS24.008 v17.0.0. Similar to GPRS timer 2, according to the format of GPRS timer 3, a value range of a timer may be computed as a product of “Timer Unit(s)” and “Timer Value(s) of each Timer Unit”. In particular, in an embodiment of FIG. 3, timer T3412 adopting the format of GPRS timer 3 may be represented by: {0˜31}*{2 s, 30 s, 1 min, 10 min, 1 h, 10 h, 320 h}, wherein “2 s” means 2 seconds, “1 min” means 1 minute, and “1 h” means 1 hour. That is, a value range of timer T3412 adopting a format of GPRS timer 3 may be {0 s˜9920 h}.

Although designed for saving IoT UE's power in a continuous service link coverage scenario, a PSM also provides an alternative to reduce unnecessary power consumption for a discontinuous coverage scenario by aligning PSM duration with a network coverage. For example, if configured appropriately, a UE may enter a PSM (e.g., when timer T3324 expires as shown in FIG. 3) when there is no network coverage (e.g., time instance T1 in time domain as shown in FIG. 3) to avoid unnecessary cell searching or measurement, and/or the UE may leave the PSM (e.g., when timer T3412 expires as shown in FIG. 3) in time when the network coverage restores (e.g., time instance T2 in time domain as shown in FIG. 3) for possible data reception. However, considering that an Active Time timer (e.g., timer T3324) and a periodic TAU/RAU timer (e.g., timer T3412) can only be configured in an Attach procedure or a TAU procedure or a RAU procedure, it is hard to predict the following duration of the UE in a CONNECTED state (i.e., when the UE will enter an IDLE state and start timers T3324 and T3412).

In the embodiments of FIG. 3, an issue is that time values determining the PSM duration can only be configured in an Attach procedure (e.g., as shown in the embodiments of FIG. 2A) or a TAU/RAU procedure (e.g., as shown in the embodiments of FIG. 2B), which makes it hard to align the PSM duration with a no-coverage window of a network for saving a UE's power in a discontinuous coverage scenario. A no-coverage window of a network may also be named as “a network no-coverage”, “a coverage interruption of a network”, “a network coverage interruption”, “a network coverage interruption duration”, “a network coverage interruption window”, or the like. Specifically, there may be following five cases, i.e., an ideal case and Cases #1-1 to #1-4 as shown in FIG. 3.
(1) In an ideal case as shown in FIG. 3, time instance T1 in time domain is the same as timer T3324 expiration, and time instance T2 in time domain is the same as timer T3412 expiration. That is, the PSM duration of the UE is aligned with the no-coverage window.
(2) In Case #1-1 as shown in FIG. 3, time instance T1 is earlier than timer T3324 expiration, and time instance T2 is the same as timer T3412 expiration. The UE remains in the IDLE state before timer T3324 expiration, and measurement or scanning for cell selection or reselection is performed, which may cause unnecessary power consumption.
(3) In Case #1-2 as shown in FIG. 3, time instance T1 is later than timer T3324 expiration, and time instance T2 is the same as timer T3412 expiration. A UE cannot be paged after entering a PSM before time instance T1, i.e., a mobile termination (MT) service is unavailable between timer T3324 expiration and time instance T1.
(4) In Case #1-3 as shown in FIG. 3, time instance T1 is the same as timer T3324 expiration, and time instance T2 is later than timer T3412 expiration. The UE triggers the TAU/RAU procedure that will fail due to no coverage, which may cause unnecessary power consumption.
(5) In Case #1-4 as shown in FIG. 3, time instance T1 is the same as timer T3324 expiration, and time instance T2 is earlier than timer T3412 expiration. The UE cannot be paged before timer T3412 expiration, i.e., a MT service is unavailable between time instance T2 and timer T3412 expiration. If the network coverage window is short and within time instance T2 to timer T3412 expiration, the UE may miss it and thus has to wait for the next coverage window for reception.

In short, Case #1-1 and Case #1-3 may lead to unnecessary power consumption, Case #1-2 and Case #1-4 are similar as in terrestrial networks (TN), but Case #1-4 may affect a user experience or a service validity considering discontinuous coverage. Therefore, embodiments of the present application aim to solve Case #1-1, Case #1-3, and Case #1-4. Case #1-2 can also be solved using the proposed principle in the embodiments of the present application.

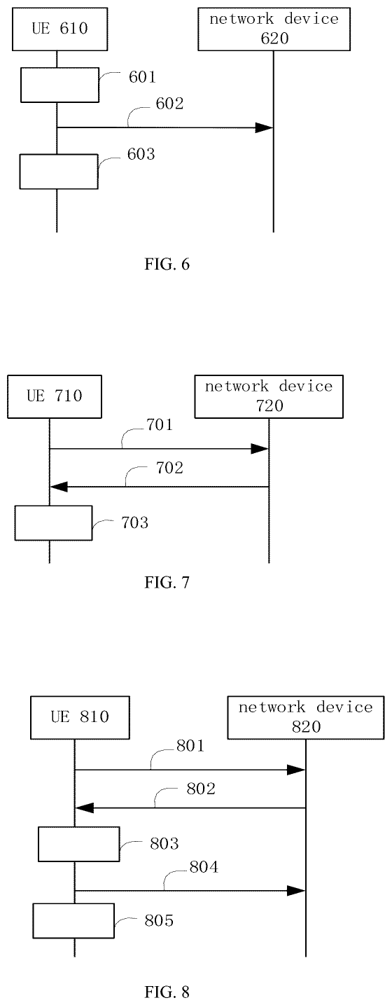

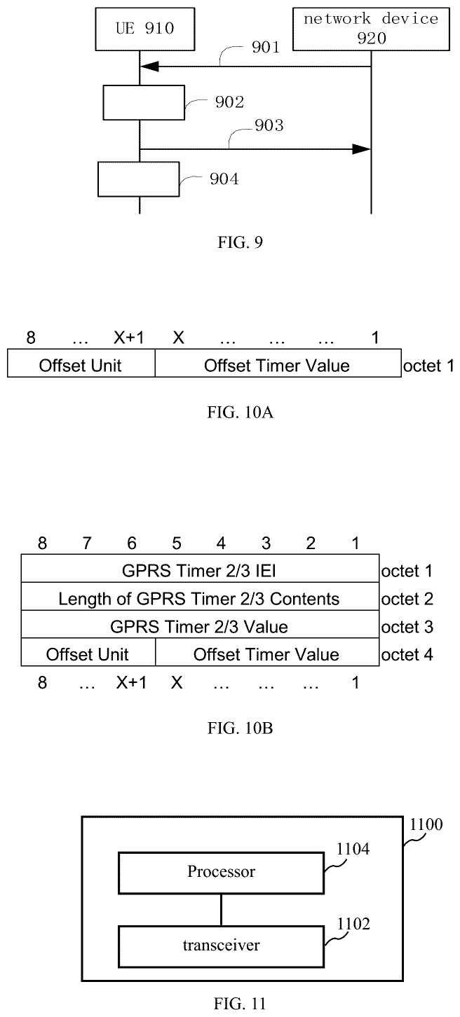

Generally, some embodiments of the present application aim to align the PSM duration of a UE with a network no-coverage window to minimize unnecessary power consumption. Some embodiments of the present application propose a method for saving a UE's power in a discontinuous coverage scenario. These embodiments allow the UE to align its PSM duration with a network coverage interruption window, to minimize unnecessary power consumption. Some embodiments of the present application introduce new behaviors of a UE for entering or leaving a PSM. Some embodiments of the present application introduce new procedures to configure the PSM duration of a UE, based on an estimation of a network coverage interruption. Some embodiments of the present application cover multiple possible implementations including a UE's decision and report (e.g., embodiments of FIG. 6 described as below), new signaling by a RAN device and/or a CN device (e.g., embodiments of FIG. 7 described as below), an enhancement for an existing mechanism (e.g., embodiments of FIGS. 8 and 9 described as below), and an implementation of a finer granularity for configuration(s) of timer T3324 or timer T3412 (e.g., embodiments of FIGS. 10A and 10B described as below). More details will be illustrated in following text in combination with the appended drawings.

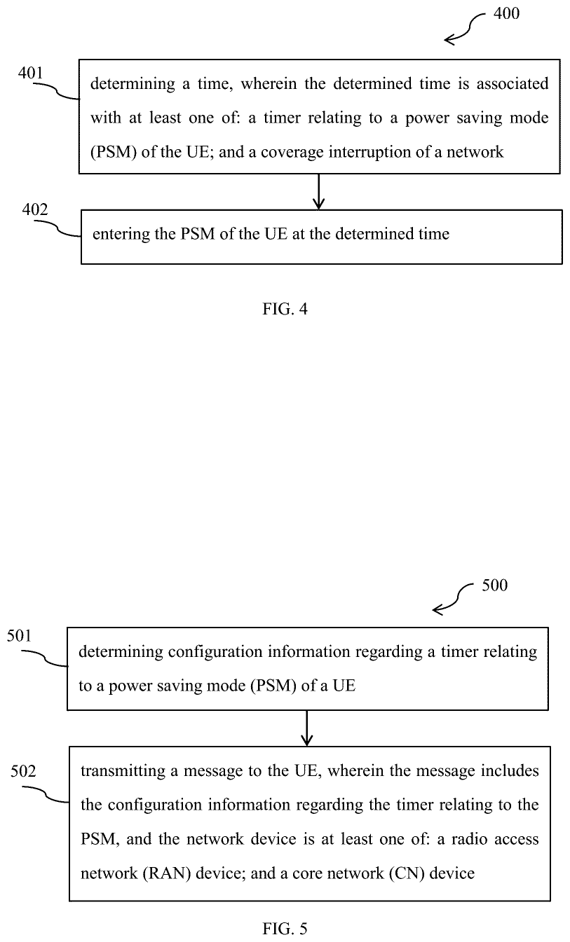

FIG. 4 illustrates an exemplary flow chart of a method for entering a PSM of a UE according to some embodiments of the present application. The exemplary method 400 illustrated in FIG. 4 may be implemented by a UE (e.g., UE 103, UE 106, UE 210, UE 310, UE 610, UE 710, UE 810, or UE 910 as illustrated and shown in any of FIGS. 1A, 1B, 2A, 2B, and 6-9). Although described with respect to a UE, it should be understood that other devices may be configured to perform a method similar to that of FIG. 4.

In the embodiments of FIG. 4, in operation 401, a UE determines time, and the determined time may be associated with “a timer relating to a PSM of the UE” and/or “a coverage interruption of a network”. In operation 402, the UE enters the PSM at the determined time. In an embodiment, if the time is associated with the coverage interruption, the UE may determine an absolute start time of the coverage interruption as the determined time.

In some embodiments, the timer relating to the PSM may include: a timer associated with the coverage interruption of the network (which may be named as CoverageInterruptionTimer or the like); a timer relating to an active time of the UE (e.g., timer T3324); and/or a timer relating to a periodic TAU procedure or a periodic RAU procedure (e.g., timer T3412). For simplicity, in the following text, the timer associated with the coverage interruption is named as “Timer 1”, the timer relating to an active time of the UE (e.g., timer T3324) is named as “Timer 2”, and the timer relating to a periodic TAU procedure or a periodic RAU procedure (e.g., timer T3412) is named as “Timer 3”.

Timer 1 (e.g., CoverageInterruptionTimer) may be configured by the UE, a RAN device in the network, and/or a CN device in the network. In some embodiments, if Timer 1 is configured by the UE, the UE could report information regarding Timer 1 to the network device (e.g., a RAN device and/or a CN device). In some embodiments, if Timer 1 is configured by a RAN device, the UE receives RRC signaling, a broadcast message, and/or a multicast message from the RAN device. In some other embodiments, if Timer 1 is configured by a CN device, the UE receives non access stratum (NAS) signaling from the CN device.

In some embodiments, Timer 1 is associated with a location of the UE, a velocity of the UE, and/or coverage information received from the network. For example, the coverage information received from the network may include: a satellite ephemeris; and/or time duration of a coverage validity of the network.

In some embodiments, if the timer relating to the PSM includes Timer 1, the UE starts Timer 1 at start time of the coverage interruption of the network. In some embodiments, the UE transmits information regarding Timer 1 to a RAN device and/or a CN device in the network. For example, the information regarding Timer 1 includes: start time of Timer 1; expiry time of Timer 1; and/or time duration of Timer 1. The start time and/or the expiry time of Timer 1 may be absolute time or relative time. The time duration of Timer 1 may be represented by “a time granularity” and “a range value of the time granularity”. As described above, a time granularity may also be named as “a timer step” or the like. A range value of the time granularity may also be named as “a timer value of a timer step” or the like.

In an embodiment, if the timer relating to the PSM includes Timer 1, the UE determines start time of Timer 1 as the time in operation 401. In a further embodiment, if the timer relating to the PSM includes both Timer 1 and Timer 2, the UE determines later time within “the start time of Timer 1” and “expiry time of Timer 2” as the time determined in operation 401. A specific example is described in FIG. 6 as follows. In another embodiment, if the timer relating to the PSM includes Timer 2, the UE determines the expiry time of Timer 2 as the time in operation 401. A specific example is described in FIG. 7 as follows. In yet another embodiment, if the time is associated with the coverage interruption and if the timer relating to the PSM includes Timer 2, the UE determines later time within “absolute start time of the coverage interruption” and “expiry time of Timer 2” as the time determined in operation 401.

In some embodiments, the UE determines further time and leaves the PSM at the further time. The further time may be associated with “the timer relating to the PSM” and/or “the coverage interruption of the network”.

In an embodiment, if the further time is associated with the coverage interruption, the UE determines absolute end time of the coverage interruption as the further time. In a further embodiment, if the timer relating to the PSM includes Timer 1, the UE determines expiry time of Timer 1 as the further time. In another embodiment, if the timer relating to the PSM includes both Timer 1 and Timer 3, the UE determines later time within “expiry time of Timer 1” and “expiry time of Timer 3” as the further time. A specific example is described in FIG. 6 as follows. In yet another embodiment, if the timer relating to the PSM includes Timer 3, the UE determines expiry time of Timer 3 as the further time. A specific example is described in FIG. 7 as follows. In yet another embodiment, if the further time is associated with the coverage interruption and if the timer relating to the PSM includes Timer 3, the UE determines later time within “absolute end time of the coverage interruption” and “expiry time of Timer 3” as the further time.

In some embodiments, the UE transmits a message to a RAN device and/or a CN device in the network. For example, the message transmitted by the UE includes at least one of following contents:
(1) A request for configuration information regarding the timer relating to the PSM. For example, the configuration information may include time length(s) of at least one of Timer 1, Timer 2, and Timer 3.
(2) A requesting reason of the request for configuration information regarding the timer relating to the PSM.
(3) Start time of the coverage interruption of the network.
(4) End time of the coverage interruption of the network.
(5) Time duration of a CONNECTED state of the UE.
(6) An indication, which indicates that the UE immediately starts the timer relating to the PSM upon receiving configuration information regarding the timer relating to the PSM.

In an embodiment, the message is firstly transmitted from the UE to the RAN device, and secondly forwarded by the RAN device to the CN device. The message transmitted by the UE may be associated with at least one of:
(1) an Attach procedure, e.g., as shown in the embodiments of FIG. 2A;
(2) a periodic TAU procedure, e.g., as shown in the embodiments of FIG. 2B;
(3) a periodic RAU procedure, e.g., as shown in the embodiments of FIG. 2B; and
(4) a PSM related procedure. A PSM related procedure represents a procedure related to a PSM of a UE, which is different from an Attach procedure, a TAU procedure, or a RAU procedure. For example, the message associated with a PSM related procedure is a message transmitted not in an Attach procedure, a TAU procedure, or a RAU procedure.

In some embodiments, the UE receives a further message from a RAN device and/or a CN device in the network, and the further message includes configuration information regarding the timer relating to the PSM. In an embodiment, the further message is firstly transmitted from the CN device to the RAN device, and secondly transmitted by the RAN device to the UE. The further message may be associated with: an Attach procedure; a periodic TAU procedure; a periodic RAU procedure; and/or a PSM related procedure. For example, the further message associated with a PSM related procedure is a message not for the Attach procedure, the TAU procedure, or the RAU procedure.

In an embodiment, the UE immediately starts the timer relating to the PSM upon receiving the further message which includes configuration information regarding the timer relating to the PSM. A specific example is described in FIG. 9 as follows. In some embodiments, the configuration information regarding the timer relating to the PSM included in the further message includes:
(1) time duration of the timer relating to the PSM; or
(2) a sum of “a time offset” and “the time duration of the timer relating to the PSM”. For instance, the time offset is equal to time duration of a connected state of the UE. A specific example is described in FIG. 8 as follows.

In some embodiments, the UE receives an additional message from the RAN device and/or the CN device, and the additional message includes a time duration offset associated with the timer relating to the PSM. The time duration offset may be represented by “a time granularity” and “a range value of the time granularity”. For example, the UE could receive additional time value of Timer 2 (e.g., timer T3324) and/or Timer 3 (e.g., timer T3412) from the network device. The additional time value of Timer 2 and/or Timer 3 may be: an offset to configured value of Timer 2 and/or Timer 3; and/or an extended value of Timer 2 and/or Timer 3. Specific examples are described in FIGS. 10A and 10B as follows.

Details described in the embodiments as illustrated and shown in FIGS. 1-3 and 5-11, especially, contents regarding a timer relating to a PSM of a UE and a network coverage interruption, are applicable for the embodiments as illustrated and shown in FIG. 4. Moreover, details described in the embodiments of FIG. 4 are applicable for all the embodiments of FIGS. 1-3 and 5-11.

FIG. 5 illustrates an exemplary flow chart of a method for determining configuration information regarding a timer relating to a PSM of a UE according to some embodiments of the present application. The exemplary method 500 illustrated in FIG. 5 may be implemented by a network device. For example, the network device is a RAN device (e.g., BS 107, BS 108, BS 220, BS 320, network device 620, network device 720, network device 820, or network device 920 as illustrated and shown in any of FIGS. 1B, 2A, 2B, and 6-9) and/or a CN device (e.g., MME 230, MME 330, network device 620, network device 720, network device 820, or network device 920 as illustrated and shown in any of FIGS. 2A, 2B, and 6-9). The RAN device and/or the CN device may also be any other possible type of network devices not shown and illustrated in the drawings of the subject application. For example, the CN device may include an access and mobility management function (AMF) entity. Although described with respect to a network device, it should be understood that other devices may be configured to perform a method similar to that of FIG. 5.

In the embodiments of FIG. 5, in operation 501, a network device determines configuration information regarding a timer relating to a PSM of a UE. In operation 502, the network device transmits a message to the UE. The message includes the configuration information regarding the timer relating to the PSM. The message may be associated with: an Attach procedure; a periodic TAU procedure; a periodic RAU procedure; and/or a PSM related procedure.

The network device is a RAN device and/or a CN device. In some embodiments, if the network device is a RAN device, the message transmitted by the network device may be RRC signaling, a broadcast message, and/or a multicast message. If the network device is a CN device, the message transmitted by the network device may be NAS signaling. In some embodiments, the message is firstly transmitted from the CN device to the RAN device and secondly transmitted by the RAN device to the UE. For example, the configuration information regarding the timer relating to the PSM may include: time duration of the timer relating to the PSM; or a sum of “a time offset” and “the time duration of the timer relating to the PSM”. The time offset may be equal to time duration of a connected state of the UE. A specific example is described in FIG. 8 as follows.

In some embodiments, the timer relating to the PSM may be immediately started upon the UE receiving the configuration information regarding the timer relating to the PSM. A specific example is described in FIG. 9 as follows. In some embodiments, the UE enters the PSM at absolute start time of a coverage interruption of a network. In some embodiments, the UE leaves the PSM at absolute end time of the coverage interruption of the network.

Similar to the embodiments of FIG. 4, in the embodiments of FIG. 5, the timer relating to the PSM may include: Timer 1 (e.g., Coverage InterruptionTimer); Timer 2 (e.g., timer T3324); and/or Timer 3 (e.g., timer T3412). Timer 1 may be configured by the UE, the RAN device; and/or the CN device. Timer 1 may be associated with a location of the UE, a velocity of the UE, and/or network coverage information. For instance, the network coverage information may include: a satellite ephemeris; and/or time duration of a coverage validity of the network device.

In an embodiment, if the timer relating to the PSM includes Timer 1, the UE starts Timer 1 at start time of the coverage interruption of the network. In an embodiment, the network device receives information regarding Timer 1 from the UE. The information regarding Timer 1 may include: start time of Timer 1; expiry time of Timer 1; and/or time duration of Timer 1. The start time and/or the expiry time of Timer 1 may be absolute time or relative time. For instance, the time duration of Timer 1 may be represented by “a time granularity” and “a range value of the time granularity”

In some embodiments, the UE enters the PSM at one of following time instances:
(1) start time of Timer 1, if the timer relating to the PSM includes Timer 1. A specific example is described in FIG. 6 as follows.
(2) later time within “start time of Timer 1” and “expiry time of Timer 2”, if the timer relating to the PSM includes both Timer 1 and Timer 2. A specific example is described in FIG. 6 as follows.
(3) expiry time of Timer 2, if the timer relating to the PSM includes Timer 2. A specific example is described in FIG. 7 as follows.
(4) later time within “absolute start time of the coverage interruption” and “expiry time of Timer 2”, if the timer relating to the PSM includes Timer 2.

In some other embodiments, the UE leaves the PSM at one of following time instances:
(1) expiry time of Timer 1, if the timer relating to the PSM includes Timer 1.
(2) later time within “expiry time of Timer 1” and “expiry time of Timer 3”, if the timer relating to the PSM includes both Timer 1 and Timer 3. A specific example is described in FIG. 6 as follows.
(3) expiry time of Timer 3, if the timer relating to the PSM includes Timer 3. A specific example is described in FIG. 7 as follows.
(4) later time within “absolute end time of the coverage interruption” and “expiry time of Timer 3”, if the timer relating to the PSM includes Timer 3.

In some embodiments, the network device determines time for the UE to enter a PSM by at least one of following manners:
(1) The network device configures Timer 1 for the UE and Timer 1 starts at the beginning of network coverage interruption for the UE, so that the UE enters a PSM when Timer 1 starts or when both Timer 1 and Timer 2 (e.g., timer T3324) start.
(2) The network device configures Timer 2 (e.g., timer T3324) for the UE, before the UE enters an IDLE or inactive state in a message other than a network response for an Attach or TAU/RAU procedure, so that the UE enters a PSM when Timer 2 expires. For example, the network device could receive a request from the UE for the configuration information of Timer 2 before reception in a message other than the Attach or TAU/RA procedure.
(3) The network device configures Timer 2 (e.g., timer T3324) for the UE, and Timer 2 can be offset by the UE with its time duration being in a CONNECTED state in a response for an Attach or TAU/RAU procedure, e.g., the time for the UE to enter a PSM is: “the received time duration of Timer 2” minus “time duration of the UE being in the CONNECTED state”.
(4) The network device configures Timer 3 (e.g., timer T3324) for the UE, and Timer 3 starts upon UE receiving a network response for an Attach or TAU/RAU procedure.

In some embodiments, the network device receives a further message from the UE. The further message may include at least one of:
(1) a request for configuration information regarding the timer relating to the PSM;
(2) a requesting reason of the request for configuration information regarding the timer relating to the PSM;
(3) start time of the coverage interruption of the network;
(4) end time of the coverage interruption of the network;
(5) time duration of a CONNECTED state of the UE; and
(6) an indication, which indicates that the UE immediately starts the timer relating to the PSM upon receiving configuration information regarding the timer relating to the PSM.

In some embodiments, the further message is firstly transmitted from the UE to the RAN device, and secondly transmitted by the RAN device to the CN device. The further message may be associated with: an Attach procedure; a periodic TAU procedure; a periodic RAU procedure; and/or a PSM related procedure.

In some embodiments, the network device transmits an additional message to the UE. The additional message includes a time duration offset associated with the timer relating to the PSM. The time duration offset may be represented by “a time granularity” and “a range value of the time granularity”. Specific examples are described in FIGS. 10A and 10B as follows.

In some embodiments, the network device determines time for the UE to leave a PSM by at least one of following manners:
(1) The network device configures Timer 1 for the UE, and Timer 1 expires at the end of network coverage interruption for the UE, so that UE leaves a PSM when Timer 1 expires or when both Timer 1 and Timer 3 (e.g., timer T3412) expire.
(2) The network device configures Timer 3 (e.g., timer T3324) for the UE before the UE enters an IDLE or inactive state in a message other than a network response for an Attach or TAU/RAU procedure, so that the UE leaves the PSM when Timer 3 expires. For example, the network device could receive a request from the UE for the time value of Timer 3 before reception in a message other than the Attach or TAU/RA procedure.
(3) The network device configures Timer 3 (e.g., timer T3324) for the UE, and Timer 3 can be offset by the UE with its time duration being in a CONNECTED state in a response for the Attach or TAU/RA procedure. For instance, the time to leave PSM is: “the received time duration of Timer 3” minus “the time duration of UE being in a CONNECTED state”. The network device may configure the time value of Timer 3 that starts upon the UE receiving a network response for the Attach or TAU/RA procedure.

Details described in the embodiments as illustrated and shown in FIGS. 1-4 and 6-11, especially, contents regarding a timer relating to a PSM of a UE and a network coverage interruption, are applicable for the embodiments as illustrated and shown in FIG. 5. Moreover, details described in the embodiments of FIG. 5 are applicable for all the embodiments of FIGS. 1-4 and 6-11.

FIG. 6 illustrates an exemplary flow chart for entering and/or leaving a PSM of a UE according to some embodiments of the present disclosure. A timer associated with a network coverage interruption (i.e., Timer 1) runs during no-coverage window. The embodiments of FIG. 6 introduce corresponding enter or leave conditions for PSM (independent or combined with an expiration of timer T3324 or timer T3412). In the embodiments of FIG. 6, a UE may request values or report the time according to no-coverage window (and a requesting reason) to a RAN device (if an inactive state is supported) or a CN device. A UE may require additional enter or leave condition(s) for a PSM. A UE may require expiration condition(s) of Timer 2 or Timer 3 (e.g., timer T3324 or timer T3412). No need to change NAS procedures of requesting and receiving Timer 2 or Timer 3. NAS procedures may need to know the final duration of the PSM (e.g., to avoid unnecessary paging).

In particular, in operation 601, UE 610 maintains a timer associated with a network coverage interruption (i.e., Timer 1). Timer 1 starts at the beginning of network coverage interruption, and expires at the end of the network coverage interruption. The start time, the expiry time, or duration of Timer 1 could be configured by UE 610 based on a location of UE 610 or a velocity of UE 610 and coverage information provided by network device 620. The coverage information provided by network device 620 may include satellite ephemeris and/or duration of coverage validity (e.g., the time when a cell is going to start or stop serving an area).

The start time, the expiry time, or the duration of Timer 1 could be configured by network device 620 (e.g., a RAN device or a CN device) taking a location or a velocity of UE 610 and/or coverage information provided by network device 620 into account. A RAN device could configure Timer 1 for UE 610 via RRC signaling or broadcast/multicast. A CN device could configure Timer 1 for UE 610 via NAS signaling.

In some embodiments, Timer 1 could be configured as at least one of following formats:
(1) Start time or Expiry time as absolute time. For instance, Timer 1 starts at 8:00 UTC and expires at 9:00 UTC.
(2) Start time or Expiry time as relative time. For instance, Timer 1 starts 5 minutes after the UE receives configuration information regarding Timer 1, and Timer 1 expires 15 minutes after the UE receives configuration information regarding Timer 1.
(3) Duration in units and values (similar to GPRS Timers as specified in 3GPP standard document TS24.008). In some embodiments, Timer 1 may be configured by the following format:

| 8 . . . X + 1 | X . . . . . . . . . 1 | |
|---|---|---|
| Timer 1 Unit | Timer 1 Value | octet 1 |

a) Timer 1 with the above format is represented by a total length of 8 bits, wherein a field of “Timer 1 Unit” includes “8-X” bits (i.e., bit 8 to bit X+1), and a field of “Timer 1 Value” includes X bits (i.e., bit X to bit 1). For example, X=5, “Timer 1 Unit” includes 3 bits, and “Timer 1 Value” includes 5 bits.
b) The field of “Timer 1 Unit” may also be named as “Timer 1 length unit”, “Timer 1 length step”, “Timer 1 step”, “Timer 1 granularity”, “Timer 1 length granularity”, or the like. The field of “Timer 1 Value” may also be named as “a range value of Timer 1 granularity”, “a range value of Timer 1 step”, “a timer value of Timer 1 granularity”, “a timer value of Timer 1 step”, “a range value of a time granularity for Timer 1”, “a range value of a time step for Timer 1”, “a timer value of a time granularity for Timer 1”, “a timer value of a time step for Timer 1”, or the like.
c) These two fields of the above format are represented by “octet 1”. In some embodiments, Bits 5 to 1 represent “Timer 1 Value”, i.e., a binary coded value for Timer 1; and Bits 6 to 8 defines “Timer 1 Unit”, i.e., a value unit for Timer 1. In an embodiment, Bits “8 7 6” of octet 1 representing “Timer 1 Unit” may be:
   1) 0 0 0 value is incremented in multiples of 10 minutes.
   2) 0 0 1 value is incremented in multiples of 1 hour.
   3) 0 1 0 value is incremented in multiples of 10 hours.
   4) 0 1 1 value is incremented in multiples of 2 seconds.
   5) 1 0 0 value is incremented in multiples of 30 seconds.
   6) 1 0 1 value is incremented in multiples of 1 minute.
   7) 1 1 0 value is incremented in multiples of 5 minutes.
   8) 1 1 1 value indicates that Timer 1 is deactivated.
d) In some other embodiments, bits in “Timer 1 Unit” and Timer 1 Value” may be different values, to represent different offset values applied to a value configured to Timer 2 and/or Timer 3.
(4) Exemplary values (similar to RRC configuration for timers). For instance, Timer 1 could be configured by following exemplary values and formats:

CoverageInterruptionInfo-r18 ::= SEQUENCE {
CoverageInterruptionTimer-r18 ENUMERATED {s5, s10, s20, s40,
s80, s160, s320, s640, s1280, spare3, spare 2, spare 1}
... }

Wherein: s5 means 5 seconds, s10 means 10 seconds, and so on; and each of spare1, spare2, and spare3 means a spare value for further extension.

In operation 602, UE 610 could report the start time or the expiry time of Timer 1 to network device 620 (e.g., a RAN device and/or a CN device). In operation 603, UE 610 may enter a PSM when Timer 1 starts or when both Timer 1 and Timer 2 (e.g., timer T3324) start. In operation 603, UE 610 may leave the PSM when Timer 1 expires or when both Timer 1 and Timer 3 (e.g., timer T3412) expire.

Details described in the embodiments as illustrated and shown in FIGS. 1-5 and 7-11, especially, contents regarding a timer relating to a PSM of a UE (e.g., Timer 1, Timer 2, or Timer 3), are applicable for the embodiments as illustrated and shown in FIG. 6. Moreover, details described in the embodiments of FIG. 6 are applicable for all the embodiments of FIGS. 1-5 and 7-11.

FIG. 7 illustrates a further exemplary flow chart for entering and/or leaving a PSM of a UE according to some embodiments of the present disclosure. In the embodiments of FIG. 7, a UE requests for latest value of timer T3324 or timer T3412 when the UE enters an IDLE state before a PSM. The UE may request values or report the time according to no-coverage window (and a requesting reason) to a network device (a RAN device and/or a CN device). The UE may require additional NAS procedures of requesting or receiving timer T3324 or timer T3412 (other than an Attach procedure, a TAU procedure, or a RAU procedure). In the embodiments of FIG. 7, there is no need to introduce an enter condition or a leave condition of a PSM of the UE. NAS knows the final duration of PSM. A finer granularity of timer T3324 or timer T3412 configuration is needed.

In particular, in operation 701, UE 710 may request to network device 720 for time value(s) of Timer 2 (e.g., timer T3324) and/or Timer 3 (e.g., timer T3412) in a message other than an Attach procedure, a TAU procedure, or a RAU procedure. In some embodiments, in operation 701, UE 710 may report the time according to no-coverage window to network device 720. In an embodiment, UE 710 may further report a requesting reason to network device 720. For example, the requesting reason may be a PSM for a network coverage interruption.

In operation 702, UE 710 may receive the time value(s) of Timer 2 (e.g., timer T3324) and/or Timer 3 (e.g., timer T3412) from network device 720 before UE 710 performs a transition to an IDLE state or an inactive state in a message other than a network response for an Attach procedure, a TAU procedure, or a RAU procedure.

In operation 703, UE 710 enters a PSM when Timer 2 (e.g., timer T3324) expires and UE 710 leaves the PSM when Timer 3 (e.g., timer T3412) expires.

Details described in the embodiments as illustrated and shown in FIGS. 1-6 and 8-11, especially, contents regarding a timer relating to a PSM of a UE (e.g., Timer 1, Timer 2, or Timer 3), are applicable for the embodiments as illustrated and shown in FIG. 7. Moreover, details described in the embodiments of FIG. 7 are applicable for all the embodiments of FIGS. 1-6 and 8-11.

FIG. 8 illustrates another exemplary flow chart for entering and/or leaving a PSM of a UE according to some embodiments of the present disclosure. In the embodiments of FIG. 8, a UE counts the duration of a CONNECTED state of the UE (or indicated by a network device) as an offset to the expiration of timer T3324 or timer T3412. The UE may request values or report the time according to a no-coverage window (and a requesting reason) to a RAN device (if an inactive state is supported) or a CN device. The UE may change expiration rule(s) of timer T3324 or timer T3412. In the embodiments of FIG. 8, there is no need to change NAS procedures of requesting or receiving timer T3324 or timer T3412. NAS may need to know the final duration of PSM. A finer granularity of timer T3324 or timer T3412 configuration is needed.

In particular, in operation 801, UE 810 may request to network device 820 for time value(s) of Timer 2 (e.g., timer T3324) and/or Timer 3 (e.g., timer T3412) in a message other than an Attach procedure, a TAU procedure, or a RAU procedure. In some embodiments, in operation 801, UE 810 may report the time according to no-coverage window to network device 820. In an embodiment, UE 810 may further report a requesting reason to network device 820. For example, the requesting reason may be a PSM for a network coverage interruption.

In operation 802, UE 810 may receive the time value(s) of Timer 2 (e.g., timer T3324) and/or Timer 3 (e.g., timer T3412) from network device 820. For example, UE 810 may receive time duration of Timer 2 (e.g., timer T3324) and/or Timer 3 (e.g., timer T3412) in a network response for an Attach procedure, a TAU procedure, or a RAU procedure. In operation 803, UE 810 may offset the received time duration of Timer 2 (e.g., timer T3324) and/or Timer 3 (e.g., timer T3412) with its time duration being in a CONNECTED state. For example, the time to enter or leave a PSM of UE 810 is computed as “the received time duration of Timer 2 (e.g., timer T3324) and/or Timer 3 (e.g., timer T3412)” minus “the time duration of UE 810 being in the CONNECTED state”.

In operation 804, UE 810 may report its time duration of being in the CONNECTED state to network device 820. In operation 805, UE 810 enters a PSM when Timer 2 (e.g., timer T3324) expires, and UE 810 leaves the PSM when Timer 3 (e.g., timer T3412) expires.

Details described in the embodiments as illustrated and shown in FIGS. 1-7 and 9-11, especially, contents regarding a timer relating to a PSM of a UE (e.g., Timer 1, Timer 2, or Timer 3), are applicable for the embodiments as illustrated and shown in FIG. 8. Moreover, details described in the embodiments of FIG. 8 are applicable for all the embodiments of FIGS. 1-7 and 9-11.

FIG. 9 illustrates an additional exemplary flow chart for entering and/or leaving a PSM of a UE according to some embodiments of the present disclosure. In the embodiments of FIG. 9, a UE starts T3324/T3412 upon configuration for a PSM. The UE may request values or report the time according to no-coverage window (and reason) to a RAN device (if an inactive state is supported) or a CN device. The UE may change starting rule(s) of timer T3324 or timer T3412. In the embodiments of FIG. 9, there is no need to change NAS procedures of requesting or receiving timer T3324 or timer T3412. NAS knows the final duration of PSM. A finer granularity of timer T3324 or timer T3412 configuration is needed. The UE may need to check if in an IDLE state when timer T3324 expires.

In particular, in operation 901, UE 910 may receive configuration information (e.g., time value(s)) of Timer 2 (e.g., timer T3324) and/or Timer 3 (e.g., timer T3412) from network device 920. For example, UE 910 may receive time duration of Timer 2 (e.g., timer T3324) and/or Timer 3 (e.g., timer T3412) in a network response for an Attach procedure, a TAU procedure, or a RAU procedure. Optionally, the configuration information (e.g., time value(s)) of Timer 2 and/or Timer 3 is received after UE 910 transmits a request (and a requesting reason, e.g., a PSM for a network coverage interruption) to network device 920 for such configuration information.

In operation 902, UE 910 may start Timer 2 (e.g., timer T3324) and/or Timer 3 (e.g., timer T3412) upon receiving the configuration information (e.g., time value(s)) from network device 920. In operation 903, UE 910 may report an indication to network device 920, and the indication indicates starting Timer 2 (e.g., timer T3324) and/or Timer 3 (e.g., timer T3412) upon the configuration information received from network device 920. In operation 904, UE 910 enters a PSM when Timer 2 (e.g., timer T3324) expires, and UE 910 leaves the PSM when Timer 3 expires.

Details described in the embodiments as illustrated and shown in FIGS. 1-8 and 10A-11, especially, contents regarding a timer relating to a PSM of a UE (e.g., Timer 1, Timer 2, or Timer 3), are applicable for the embodiments as illustrated and shown in FIG. 9. Moreover, details described in the embodiments of FIG. 9 are applicable for all the embodiments of FIGS. 1-8 and 10A-11.

FIGS. 10A and 10B illustrate two exemplary formats of an offset time value for a timer relating to a PSM of a UE according to some embodiments of the present disclosure. The embodiments of FIG. 10A may refer to an exemplary format of an offset time value for Timer 2 (e.g., timer T3324) and/or Timer 3 (e.g., timer T3412). The embodiments of FIG. 10B may refer to a further exemplary format of an offset time value for Timer 2 (e.g., timer T3324) and/or Timer 3 (e.g., timer T3412).

In the embodiments of FIG. 10A or FIG. 10B, a UE could receive additional time value of Timer 2 and/or Timer 3 from a network device as “an offset value” applied to a value configured to Timer 2 and/or Timer 3. The additional time value may be included in a network response from the network device for an Attach procedure or a TAU procedure or a RAU procedure. The offset value applied to Timer 2 and/or Timer 3 may also be named as “an extended value” applied to Timer 2 and/or Timer 3 or the like. In some embodiments, a UE could receive an offset value applied to timer T3324 and/or timer T3412, and the offset value adopts the exemplary format as shown in FIG. 10A or FIG. 10B.

As shown in FIGS. 10A and 10B, an offset value applied to Timer 2 and/or Timer 3 is represented by two fields with a total length of 8 bits, wherein a field of “Offset Unit” includes “8-X” bits (i.e., bit 8 to bit X+1), and a field of “Offset Timer Value” includes X bits (i.e., bit X to bit 1). For example, X=5, “Offset Unit” includes 3 bits, and “Offset Timer Value” includes 5 bits.

In the embodiments of FIGS. 10A and 10B, the field of “Offset Unit” may also be named as “Offset length unit”, “Offset length step”, “Offset step”, “Offset granularity”, “Offset length granularity”, “Extended length unit”, “Extended length step”, “Extended step”, “Extended granularity”, “Extended length granularity”, or the like.

In the embodiments of FIGS. 10A and 10B, the field of “Offset Timer Value” may also be named as “a range value of an offset time granularity”, “a range value of an offset time step”, “a timer value of an offset time granularity”, “a timer value of an offset time step”, “a range value of an extended time granularity”, “a range value of an extended time step”, “a timer value of an extended time granularity”, “a timer value of an extended time step”, or the like.

In the embodiments of FIG. 10A, two fields of the exemplary format of an offset value applied to Timer 2 and/or Timer 3 are represented by “octet 1”. In the embodiments of FIG. 10B, two fields of the further exemplary format of an offset value applied to Timer 2 and/or Timer 3 are represented by “octet 4”, since “octet 1”, “octet 2”, and “octet 3” represent three fields of a format of a GPRS timer 2 or a GPRS timer 3 as specified in 3GPP standard document TS24.008 v17.0.0. As shown in FIG. 10B, Bits 1 to 8 in “octet 1” represents GPRS Timer 2/3 IEI, Bits 1 to 8 in “octet 2” represents Length of GPRS Timer 2/3 Contents, and Bits 1 to 8 in “octet 3” represents GPRS Timer 2/3 Value. In other words, in the embodiments of FIG. 10A, the offset value applied to Timer 2 and/or Timer 3 may be individually indicated to the UE; while in the embodiments of FIG. 10B, the offset value applied to Timer 2 and/or Timer 3 are extended based on the format of a GPRS timer 2 or a GPRS timer 3 as specified in 3GPP standard document TS24.008 v17.0.0.

In some embodiments of FIGS. 10A and 10B, Bits 5 to 1 represent “Offset Timer Value”, i.e., a binary coded offset value for Timer 2 and/or Timer 3; and Bits 6 to 8 define “Offset Unit”, i.e., an offset value unit for Timer 2 and/or Timer 3. In an embodiment, Bits “8 7 6” of octet 1 as shown in FIG. 10A or FIG. 10B representing “Offset Unit” may be:
(1) 0 0 0 value is incremented in multiples of 10 minutes.
(2) 0 0 1 value is incremented in multiples of 1 hour.
(3) 0 1 0 value is incremented in multiples of 5 minutes.
(4) 0 1 1 value is incremented in multiples of 2 seconds.
(5) 1 0 0 value is incremented in multiples of 30 seconds.
(6) 1 0 1 value is incremented in multiples of 1 minute.
(7) 1 1 0 value is incremented in multiples of 5 seconds.
(8) 1 1 1 value indicates that Timer 2 and/or Timer 3 is deactivated.

In some other embodiments of FIGS. 10A and 10B, bits in “Offset Unit” and “Offset Timer Value” may be different values, to represent different offset values applied to a value configured to Timer 2 and/or Timer 3.

Details described in the embodiments as illustrated and shown in FIGS. 1-9 and 11, especially, contents regarding a timer relating to a PSM of a UE (e.g., Timer 2 or Timer 3), are applicable for the embodiments as illustrated and shown in FIGS. 10A and 10B. Moreover, details described in the embodiments of FIGS. 10A and 10B are applicable for all the embodiments of FIGS. 1-9 and 11.

FIG. 11 illustrates an exemplary block diagram of an apparatus according to some embodiments of the present application. As shown in FIG. 11, the apparatus 1100 may include at least one processor 1104 and at least one transceiver 1102 coupled to the processor 1104. The apparatus 1100 may be a UE or a network device (e.g., a RAN device and/or a CN device).

Although in this figure, elements such as the at least one transceiver 1102 and processor 1104 are described in the singular, the plural is contemplated unless a limitation to the singular is explicitly stated. In some embodiments of the present application, the transceiver 1102 may be divided into two devices, such as a receiving circuitry and a transmitting circuitry. In some embodiments of the present application, the apparatus 1100 may further include an input device, a memory, and/or other components.

In some embodiments of the present application, the apparatus 1100 may be a UE. The processor 1104 may be configured: to determine time; and to enter a PSM of the UE at the time, wherein the time is associated with a timer relating to the PSM of the UE and/or a coverage interruption of a network.

In some embodiments of the present application, the apparatus 1100 may be a network device (e.g., a RAN device and/or a CN device). The transceiver 1102 may be configured to determine configuration information regarding a timer relating to a PSM of a UE. The transceiver 1102 may be configured to transmit a message to the UE, wherein the message includes the configuration information regarding the timer relating to the PSM.

In some embodiments of the present application, the apparatus 1100 may further include at least one non-transitory computer-readable medium. In some embodiments of the present disclosure, the non-transitory computer-readable medium may have stored thereon computer-executable instructions to cause a processor to implement the method with respect to a UE or a network device (e.g., a RAN device and/or a CN device) as described above. For example, the computer-executable instructions, when executed, cause the processor 1104 interacting with transceiver 1102, so as to perform operations of the methods, e.g., as described in view of any of FIGS. 4-10B.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

1.-15. (canceled)

16. A user equipment (UE) for wireless communication, the user equipment comprising:
a processor; and
a wireless transceiver coupled to the processor, wherein the processor is configured to:
determine a time associated with one of a timer relating to a power saving mode (PSM) of the UE and a coverage interruption of a network; and
enter the power saving mode of the UE at the determined time.

17. The UE of claim 16, wherein the processor is configured to:
determine a second time associated with at least one of: the timer relating to the PSM; and the coverage interruption of the network; and
leaving the PSM of the UE at the second time, wherein the second time is

18. The UE of claim 16, wherein the processor is configured to:
transmit a first message to at least one of a radio access network (RAN) device in the network and a core network (CN) device in the network; and
wherein the first message includes at least one of:
a request for configuration information regarding the timer relating to the PSM;
a reason for requesting the configuration information;
a start time of the coverage interruption of the network;
an end time of the coverage interruption of the network;
a time duration of a connected state of the UE; and
an indication for indicating that the timer related to the PSM is immediately started upon the UE receiving the configuration information.

19. The UE of claim 18, wherein the processor is configured to:
receive a second message from at least one of a radio access network (RAN) device in the network and a core network (CN) device in the network;
wherein the second message includes configuration information regarding the timer related to the PSM.

20. The UE of claim 19, wherein at least one of the first message and the second message is associated with at least one of:
an attach procedure;
a periodic tracking area update (TAU) procedure;
a periodic registration area update (RAU) procedure; and
a PSM related procedure.

21. The UE of claim 19, wherein the processor is configured to:
immediately starting the timer relating to the PSM upon receiving the configuration information included in the second message.

22. The UE of claim 19, wherein the configuration information includes one of:
time duration of the timer relating to the PSM; and
a sum of a time offset and the time duration of the timer relating to the PSM.

23. The UE of claim 22, wherein the time offset is equal to time duration of a connected state of the UE.

24. The UE of claim 16, wherein the timer related to the PSM includes at least one of:
a timer associated with the coverage interruption;
a timer related to an active time of the UE; and
a timer related to one of a periodic tracking area update (TAU) procedure or a periodic registration area update (RAU) procedure.

25. The UE of claim 24, wherein the processor is configured to:
transmit, to at least one of a radio access network (RAN) device and a core network (CN) device in the network, information regarding the timer associated with the coverage interruption.

26. The UE of claim 24, wherein to determine the first time, the processor is configured to:
in response to the timer related to the PSM including the timer associated with the coverage interruption, determine start time of the timer associated with the coverage interruption as the first time;
in response to the timer related to the PSM including both the timer associated with the coverage interruption and the timer relating to the active time, determine later time within the start time of the timer associated with the coverage interruption and expiry time of the timer relating to the active time as the first time;
in response to the timer related to the PSM including the timer relating to the active time, determine the expiry time of the timer relating to the active time as the first time; and
in response to the first time being associated with the coverage interruption and in response to the timer related to the PSM including the timer related to the active time, determine a later time within absolute start time of the coverage interruption and the expiry time of the timer related to the active time as the first time.

27. The UE of claim 24, wherein determining the second time further comprises one of:
in response to the timer relating to the PSM including the timer associated with the coverage interruption, determine expiry time of the timer associated with the coverage interruption as the second time;
in response to the timer relating to the PSM including both the timer associated with the coverage interruption and the timer relating to the TAU procedure or the RAU procedure, determine later time within the expiry time of the timer associated with the coverage interruption and expiry time of the timer relating to the TAU procedure or the RAU procedure as the second time;
in response to the timer relating to the PSM including the timer relating to the TAU procedure or the RAU procedure, determine the expiry time of the timer relating to the TAU procedure or the RAU procedure as the second time; and
in response to the second time being associated with the coverage interruption and in response to the timer relating to the PSM including the timer relating to the TAU procedure or the RAU procedure, determine later time within absolute end time of the coverage interruption and the expiry time of the timer relating to the TAU procedure or the RAU procedure as the second time.

28. The UE of claim 16, wherein the processor is configured to:
receive a third message from at least one of a radio access network (RAN) device in the network and a core network (CN) device in the network;
wherein the third message includes a time duration offset associated with the timer relating to the PSM.

29. A method performed by a user equipment (UE), the method comprising:
determining a first time associated with at least one of a timer relating to a power saving mode (PSM) of the UE and a coverage interruption of a network; and
entering a power saving mode of the UE at the first time.

30. The method of claim 29, further comprising:
determining a second time associated with at least one of the timer relating to the PSM and the coverage interruption of the network; and
leaving the PSM of the UE at the second time.

31. The method of claim 29, further comprising:
transmitting a first message to at least one of a radio access network (RAN) device in the network and a core network (CN) device in the network; and
wherein the first message includes at least one of:
a request for configuration information regarding the timer relating to the PSM;
a requesting reason of the request for the configuration information;
a start time of the coverage interruption of the network;
a end time of the coverage interruption of the network;
a time duration of a connected state of the UE; and
an indication for indicating that the timer relating to the PSM is immediately started upon the UE receiving the configuration information.

32. The method of claim 31, further comprising:
receiving a second message from at least one of: a radio access network (RAN) device in the network, and a core network (CN) device in the network;
wherein the second message includes configuration information regarding the timer relating to the PSM;
wherein at least one of the first message and the second message is associated with at least one of:
an attach procedure;
a periodic tracking area update (TAU) procedure;
a periodic registration area update (RAU) procedure; and
a PSM related procedure.

33. The method of claim 32, further comprising:
immediately starting the timer relating to the PSM upon receiving the configuration information;
wherein the configuration information includes one of time duration of the timer relating to the PSM; and a sum of a time offset and the time duration of the timer relating to the PSM; and
wherein the time offset is equal to a time duration of a connected state of the UE.

34. The method of claim 29, wherein the timer relating to the PSM includes at least one of:
a timer associated with the coverage interruption;
a timer relating to an active time of the UE; and
a timer relating to a periodic tracking area update (TAU) procedure or a periodic registration area update (RAU) procedure; and
the method further comprises:
transmitting, to at least one of a radio access network (RAN) device and a core network (CN) device in the network, information regarding the timer associated with the coverage interruption;
wherein determining the first timer further comprises one of:
in response to the timer relating to the PSM including the timer associated with the coverage interruption, determining start time of the timer associated with the coverage interruption as the first time;
in response to the timer relating to the PSM including both the timer associated with the coverage interruption and the timer relating to the active time, determining later time within the start time of the timer associated with the coverage interruption and expiry time of the timer relating to the active time as the first time;
in response to the timer relating to the PSM including the timer relating to the active time, determining the expiry time of the timer relating to the active time as the first time; and
in response to the first time being associated with the coverage interruption and in response to the timer relating to the PSM including the timer relating to the active time, determining later time within absolute start time of the coverage interruption and the expiry time of the timer relating to the active time as the first time; and
wherein determining the second time further comprises one of:
in response to the timer relating to the PSM including the timer associated with the coverage interruption, determining and expiry time of the timer associated with the coverage interruption as the second time;
in response to the timer relating to the PSM including both the timer associated with the coverage interruption and the timer relating to the TAU procedure or the RAU procedure, determining a later time within the expiry time of the timer associated with the coverage interruption and expiry time of the timer relating to the TAU procedure or the RAU procedure as the second time;
in response to the timer relating to the PSM including the timer relating to the TAU procedure or the RAU procedure, determining the expiry time of the timer relating to the TAU procedure or the RAU procedure as the second time; and
in response to the second time being associated with the coverage interruption and in response to the timer relating to the PSM including the timer relating to the TAU procedure or the RAU procedure, determining a later time within absolute end time of the coverage interruption and the expiry time of the timer relating to the TAU procedure or the RAU procedure as the second time.

35. A network device for wireless communication, the network device comprising:
a processor, and
a wireless transceiver coupled to the processor, wherein the processor is configured to:
determine configuration information regarding a timer relating to a power saving mode (PSM) of a user equipment (UE); and
transmit, via the wireless transceiver, a message to the UE, wherein the message includes the configuration information regarding the timer relating to the PSM, and wherein the network device is at least one of a radio access network (RAN) device and a core network (CN) device.
